(19) United States
(12) Patent Application Publication
(10) Pub. No.: US 2003/0207458 A1
(43) Pub. Date: Nov. 6, 2003

(54) Exogenous oxidant test detection method and test strip for adulterated urine samples

(76) Inventor: Taya Sookbumroong, Yorba Linda, CA (US)

Correspondence Address: STRADLING YOCCA CARLSON & RAUTH, IP Department, 660 Newport Center Drive, Suite 1600, P.O. Box 7680, Newport Beach, CA, 92660-6441, US

(21) Appl. No.: 10/139,882

(22) Filed: May 6, 2002

(51) Int. Cl. G01N 21/77

(52) U.S. Cl. 436/62; 436/8; 436/18; 436/91; 436/164; 436/169; 436/166; 422/55; 422/56; 252/408.1

(57) ABSTRACT

A reagent for detecting exogenous oxidants in urine comprises tetramethylbenzidine, an acidic buffer, a catalyst, a medium for carrying out chemical reactions, and a resinous material. The reagent may be utilized in liquid form or may be applied to a test strip.

### FIELD OF THE INVENTION

The present invention relates generally to chemical reagents. The present invention relates more particularly to a chemical reagent for detecting exogenous oxidants in urine and includes a test strip utilizing the chemical reagent.

### BACKGROUND OF THE INVENTION

Drug testing, such as in the workplace, is becoming very popular. The popularity of drug testing is being driven by both a desire to decrease the occurrence of the illicit drug use and by the decreasing cost and ready availability of such drug tests. Typically, drug testing is performed by using chemical reagents to detect the presence of drugs in a test subject's urine.

Since hiring and continued employment may depend upon passing a drug test and since urine-based drug testing is the most common method for testing for the use of illicit drugs, many drug users have turned to the use of adulterants in an attempt to pass drug tests. In the United States, experts estimate that 4% of urine samples which are submitted for drug testing have been adulterated in an attempt to mask the presence of illicit drugs.

Adulterants are substances which can be added to a urine sample in an attempt to mask the presence of one or more drugs in the urine sample. Adulterants typically have a masking or neutralizing effect on either the drugs themselves or on drug metabolites. Thus, drug tests which indicate the presence of either the drugs themselves or drug metabolites are rendered incapable of performing reliable detection.

Many different adulterants are known. Adulterants vary widely in chemical composition. Different adulterants utilize a variety of different mechanisms for masking the presence of drugs in urine. Quite often, one adulterant will work with a particular drug, but not with other drugs.

One popular example of such an adulterant is Kiflex. Another example of an adulterant is CLEAN-X. CLEAN-X is a crystal additive which is known to be particularly effective for masking the major metabolite of marijuana. Another example of an adulterant is Diamond Purify Crystal. Other commercially available adulterants include nitrite (with product names such as Klear and Whizzies), acids (with product names such as THC-FREE and Amber 13), detergents (with product names such as Mary Jane Super Clean 13, Purafyzat and Test Clean), glutaraldehyde (with product names such as Instant Clean, ADD-It-ive), oxidizing agents (with product names such as Stealth, Clear Choice and Urine Luck), as well as mixed reagents (with product names such as Lucky Lab LL418). Such adulterants are readily available, and therefore widely used.

Various commonly available materials are frequently used as adulterants. Such commonly available materials include water, bleach, detergent, eye drops, baking soda, iodine tincture and vinegar.

Many such commonly used adulterants are oxidants. Since such oxidants are not eliminated from the test subject's body in the urine sample, such oxidants are referred to as exogenous oxidants.

It has been found that exogenous oxidants are sometimes very effective at masking the presence of illicit drugs in a test subject's urine. This is true during both the screening and confirmation test processes. Indeed, the use of exogenous oxidants has been particularly effective in foiling some laboratory drug testing methodologies, such as the EMIT assays.

The Internet provides easy access to advertisements which recommend the purchase of a number of different commercially available adulterants. The Internet also provides recommendations for the use of readily available materials as adulterants.

Tests for detecting the presence of adulterants in urine samples used for drug testing are known. Although the use of such contemporary tests to solve the problem of detecting adulterants in urine samples has been generally successful, such prior art adulterant detection tests suffer from inherent deficiencies. As discussed above, there are various different adulterants which contain exogenous oxidants which are commonly used to mask the presence of drugs in urine. Contemporary attempts to detect the presence of such exogenous oxidants involve the use of oxidant specific reagents. That is, a separate test, each separate test typically utilizing a specific separate reagent, must generally be performed so as to detect the presence of each indifferent exogenous oxidant for which such detection is desired.

In view of the foregoing, it is desirable to provide a single detection mechanism which is capable of detecting the presence of multiple different exogenous oxidants in urine, such as when the exogenous oxidants are used to mask the presence of drugs during urine screening prior to drug testing.

### SUMMARY OF THE INVENTION

The present comprises a reagent for detecting exogenous oxidants in urine. The reagent comprises tetramethylbenzidine. According to the preferred embodiment of the present invention, tetramethylbenzidine is mixed with an acidic buffer, a catalyst, a medium for carrying out chemical reactions, and a resinous material. The reagent may be used in a liquid form or may be deposited upon a test strip to facilitate testing for the presence of exogenous oxidants in urine.

### BRIEF DESCRIPTION OF THE DRAWINGS

FIG. 1 is a top view of a test strip having a pad formed upon a distal end thereof, wherein the pad contains a chemical reagent for detecting the presence of exogenous oxidants in urine, according to the present invention;

FIG. 2 is a top view of a test strip having a plurality of pads formed upon a distal end thereof, wherein some of the pads contain chemical reagents for detecting the presence of different drugs in urine and wherein at least one of the pads contains a chemical reagent for detecting the presence of exogenous oxidants in the urine, according to the present invention;

FIG. 3 is a chart showing absorbance versus wavelength for pyridinium chlorochromate in deionized water for a dry pad such as those of FIGS. 1 and 2;

FIG. 4 is a chart showing absorbance versus wavelength for potassium nitrite in deionized water for a dry pad such as those of FIGS. 1 and 2;

FIG. 5 is a chart showing absorbance versus wavelength for urine with sodium hypochlorite in deionized water for a dry pad such as those of FIGS. 1 and 2;

FIG. 6 is a chart showing absorbance versus wavelength for pyridinium chlorochromate in deionized water for a liquid reagent;

FIG. 7 is a chart showing absorbance versus wavelength for potassium nitrite in deionized water for a liquid reagent; and

FIG. 8 is a chart showing absorbance versus wavelength for urine with sodium hypochlorite in deionized water for a liquid reagent.

### DETAILED DESCRIPTION OF THE INVENTION

The detailed description set forth below in connection with the appended drawings is intended as a description of the presently preferred embodiment of the invention, and is not intended to represent the only form in which the present invention may be constructed or utilized. The description sets forth the functions of the invention and the sequence of steps for constructing and operating the invention in connection with the illustrated embodiment. It is to be understood, however, that the same or equivalent functions and sequences may be accomplished by different embodiments that are also intended to be encompassed within the spirit and scope of the invention.

The present invention comprises a chemical reagent for detecting exogenous oxidants in urine which are commonly utilized to mask the presence of drugs in urine during urine drug testing. Examples of such exogenous oxidants include nitrites, pyridinium chlorochromate, and hypochlorites such as common bleach. Various peroxides are also known to be used for masking the presence of drugs in urine during urine drug testing.

The chemical reagent of the present invention comprises 3,3′,5,5′-tetramethylbenzidine, dihydrochloride dihydrate (hereafter referred to as tetramethylbenzidine or TMB). According to the preferred embodiment of the present invention, the chemical reagent further comprises an acidic buffer, a catalyst, a medium for carrying out chemical reactions, and a resinous material.

The acidic buffer preferably comprises an anhydrous acid, such as anhydrous citric acid.

The catalyst preferably comprises an enzyme catalyst such as peroxidase.

The medium for carrying out chemical reactions preferably comprises a solvent medium for carrying out chemical reactions, such as dimethyl sulfoxide.

The resinous material preferably comprises a water soluble resinous material, such as polyvinyl pyrrolidone.

According to the preferred embodiment of the present invention, anhydrous citric acid preferably has a concentration between approximately 0.05 (wt/Vol) % and approximately 5.0 (wt/Vol) %, and preferably has a concentration of approximately 1.0 (wt/Vol) %.

According to the preferred embodiment of the present invention, peroxidase preferably has a concentration between approximately 0.003 (wt/Vol) % and approximately 0.030 (wt/Vol) % and preferably has a concentration of approximately 0.012 (wt/Vol) %.

According to the preferred embodiment of the present invention, tetramethylbenzidine preferably has a concentration between approximately 0.020 (wt/Vol) % and approximately 0.300 (wt/Vol) % and preferably has a concentration of approximately 0.11 (wt/Vol) %.

According to the preferred embodiment of the present invention, dimethyl sulfoxide preferably has a concentration of between approximately 20 (wt/Vol) % and approximately 70 (wt/Vol) % and preferably has a concentration of approximately 50 (wt/Vol) %.

According to the preferred embodiment of the present invention, polyvinyl pyrrolidone preferably has a concentration of between approximately 0.1 (wt/Vol) % and approximately 2.0 (wt/Vol) % and preferably has a concentration of approximately 0.5 (wt/Vol) %.

The reagent of the present invention may be utilized either as a liquid or may be applied to an absorbent material of a test strip. When the reagent of the present invention is used as a liquid, a quantity of the liquid may be mixed with urine so as to detect the presence of an exogenous oxidant within the urine.

When the reagent of the present invention is applied to a test strip, then the reagent will typically be disposed within an absorbent pad formed to the test strip, according to well known principles. Alternatively, the reagent of the present invention may be applied directly to the test strip, without being disposed within an absorbent pad formed thereon.

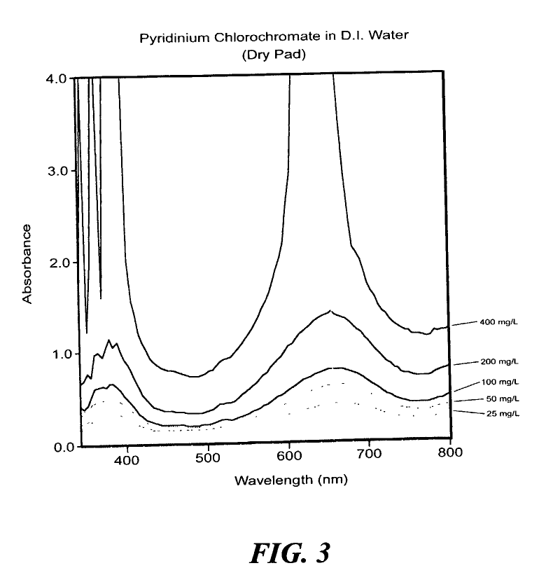

Whether the reagent of the present invention is used in liquid form or is used on a test strip, color changes which indicate the presence of an exogenous oxidant may be observed either by a human eye or by an optical or electro-optical sensor. These color changes are indicated in the graphs of FIGS. 3-8, wherein absorbance versus wavelength for various adulterants, for both dry and liquid reagent, are provided. Thus, the chemical reagent of the present invention is suitable for use in automated sampling and detection processes.

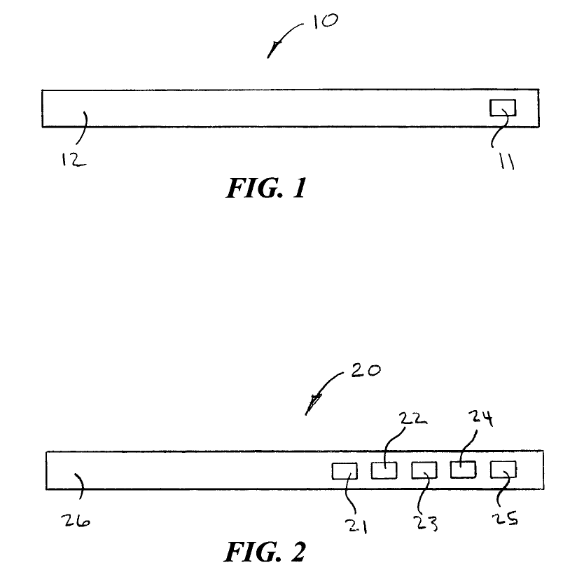

One example of the test strip coupled for use with the present invention is shown in FIG. 1. The test strip 10 may be formed of paper, wood, a polymer, or any other substantially nonreactive material which will not alter the test results due to undesirable chemical reactions therewith.

A pad 11 of absorbent material, such as cotton or another absorbent material which, like the strip 10, will not undesirably alter test results due to chemical reactions therewith, may be utilized. That is, the reagent of the present invention may be absorbed into the pad 11.

Alternatively, the chemical reagent of the present invention may be applied directly to the elongate material 12 which defines the test strip 10 and substantially dried thereupon without the use of an absorbent material.

Referring now to FIG. 2, alternative configuration of the test strip 20 comprises an elongate strip 26 of material having a plurality of absorbent pads 21-25 formed upon a distal end thereof. The plurality of absorbent pads 21-25 may comprise, for example, absorbent pads containing different chemical reagents which are suitable for detecting different drugs in a urine sample. At least one of the absorbent pads 21-25 contains a chemical reagent of the present invention, such that exogenous oxidants may likewise be detected.

Referring now to FIGS. 3-8, the absorption spectra for several test samples, wherein exogenous oxidants are detected according to the present invention, are given. The absorption spectra for the test samples which utilized a dry pad (FIGS. 3-5) where obtained by preparing the liquid reagent and applying the liquid reagent to a test pad such that the liquid reagent was absorbed onto the test pad. The test pad comprised a cellulose based matrix designed to have a poracity which readily absorbed the liquid reagent and permitted the liquid reagent to maintain it's activity. An attempt was made to maintain color consistency between test pads before their use. When the test pad contacted a urine sample which is adultrated with an oxident, the color of the test pad changed. Changes in color or color intensity of the test pads indicated the presence of one or more oxidants.

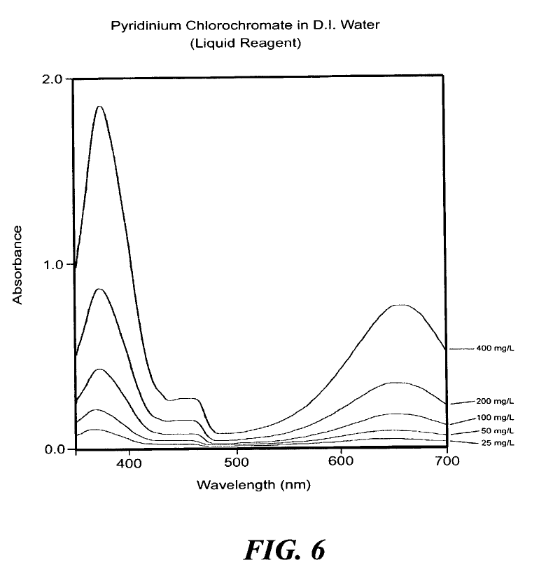

The absorption spectra for the liquid reagent (FIGS. 6-8) were provided by mixing urine with the liquid reagent and testing the mixture using a standard spectrophotometer. The changes in color or color intensity of the liquid mixture indicate the presence of oxidants.

To determine the color changes, in the dry pad a technique using rapid fire tungsten based spectrophotometery was utilized. This technique utilizes a spectrometer which has the capability of providing absorbance/transmittance/reflectance peaks in visual spectra and chromaticity coordinates on solid colored surfaces. The spectrometer utilized has the ability to scan at 5 nm intervals and to provide a real visual color graph of the surface with illuminate tristimulus values in X, Y and Z coordinates.

With particular reference to FIG. 3, a chart shows absorbance versus wavelength for pyridinium chlorochromate in deionized water for a dry pad such as those of FIGS. 1 and 2. As can clearly be seen, absorbance at approximately 650 nm is very high, particularly for the 400 mg/L sample. Absorbance is also high around approximately 390 nm.

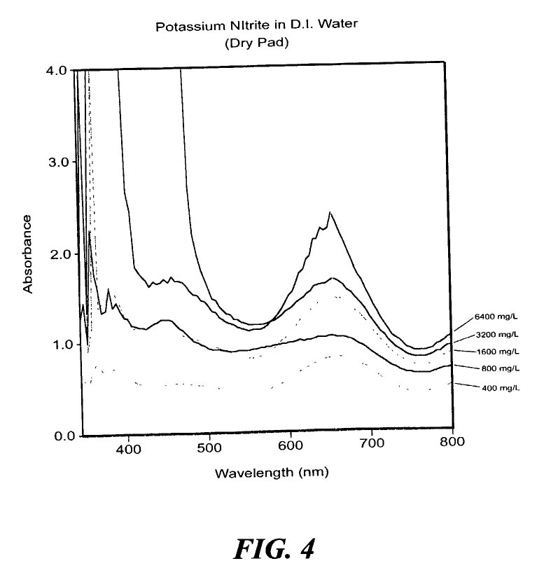

With particular reference to FIG. 4, a chart shows absorbance versus wavelength for potassium nitrite in deionized water for a dry pad such as those of FIGS. 1 and 2. Absorbance is very high below approximately 500 nm, particularly for the 6,400 mg/L sample. Absorbance also peaks at about approximately 650 nm.

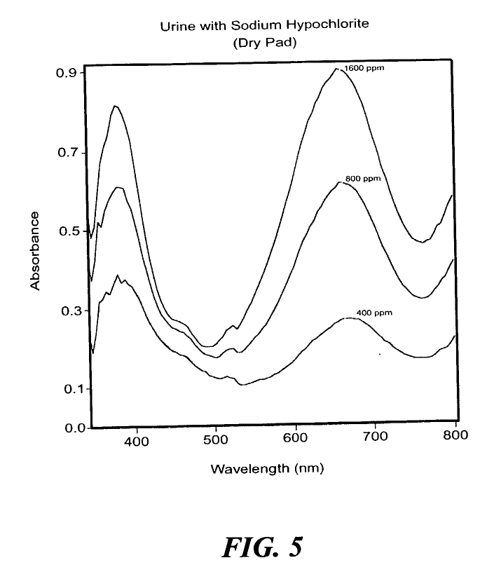

With particular reference to FIG. 5, a chart shows absorbance versus wavelength for urine with sodium hypochlorite in deionized water for a dry pad such as those of FIGS. 1 and 2. Absorbance peaks at approximately 660 nm, particularly for the 1,600 ppm sample. Absorbance also peaks at approximately 390 nm.

With particular reference to FIG. 6, a chart shows absorbance versus wavelength for pyridinium chlorochromate in deionized water for a liquid reagent. Absorbance peaks at approximately 375 nm, particularly for the 400 mg/L sample. Absorbance also peaks at approximately 660 nm.

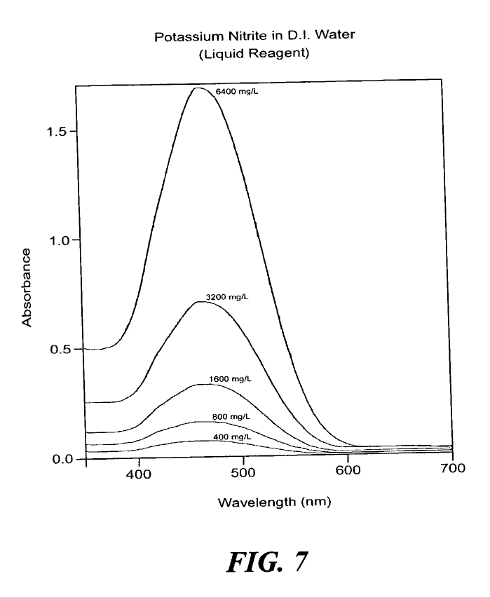

With particular reference to FIG. 7, a chart shows absorbance versus wavelength for potassium nitrite in deionized water for a liquid reagent. Absorbance peaks at approximately 475 nm, particularly for the 6,400 mg/L sample.

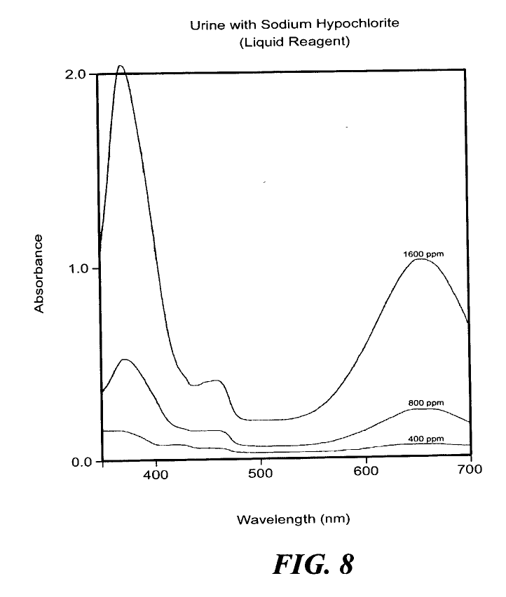

With particular reference to FIG. 8, a chart shows absorbance versus wavelength for urine with sodium hypochlorite in deionized water for a liquid reagent. Absorbance peaks at approximately 380 nm, particularly for the 1,600 ppm sample. Absorbance also peaks at approximately 660 nm.

The charts of FIGS. 4-8 clearly show that different exogenous oxidants can easily be detected with the chemical reagent of the present invention. This can be accomplished either visually or using an automated process, such as those which utilize electronic sensors.

Thus, according to the present invention, a single chemical reagent is provided, which facilitates testing for multiple oxidant adulterants in urine samples, thereby facilitating less costly, more convenient, less time consuming, and easier testing for such oxidants. Indeed, the present invention facilitates more efficient use of instruments for such analysis, particularly wherein such instruments have a limited number of reagent channels.

It is understood that the exemplary chemical reagent described herein and shown in the drawings represents only a presently preferred embodiment of the invention. Indeed, various modifications and additions may be made to such embodiment without departing from the spirit and scope of the invention. For example, those skilled in the art will appreciate that various different acids or acidic buffers, catalyst, media for carrying out chemical reactions and resinous materials are likewise suitable for use in the present invention. Thus, these and other modifications and additions may be obvious to those skilled in the art and may be implemented to adapt the present invention for use in a variety of different applications.

What is claimed is:

1. A reagent for detecting exogenous oxidants in urine, the reagent comprising tetramethylberizidine.

2. The reagent as recited in claim 1, further comprising:
an acidic buffer;
a catalyst; and
a medium for carrying out chemical reactions.

3. The reagent as recited in claim 1, further comprising:
an acidic buffer;
a catalyst;
a medium for carrying out chemical reactions; and
a resinous material.

4. The reagent as recited in claim 1, further comprising:
an anhydrous acid;
an enzyme catalyst;
a solvent medium for carrying out chemical reactions; and
a water soluble resinous material.

5. The reagent as recited in claim 1, further comprising:
anhydrous citric acid;
peroxidase;
dimethyl sulfoxide; and
polyvinyl pyrrolidone.

6. The reagent as recited in claim 1, further comprising:
anhydrous citric acid having a concentration of between approximately 0.05 (wt/Vol) % and approximately 5.0 (wt/Vol) %;
peroxidase having a concentration of between approximately 0.003 (wt/Vol) % and approximately 0.030 (wt/Vol) %;
dimethyl sulfoxide having a concentration of between approximately 20 (wt/Vol) % and approximately 70 (wt/Vol) %;
polyvinyl pyrrolidone having a concentration of between approximately 0.1 (wt/Vol) % and approximately 2.0 (wt/Vol) %; and
wherein the tetramethylbenzidine has a concentration of between approximately 0.020 (wt/Vol) % and approximately 0.300 (wt/Vol) %.

7. The reagent as recited in claim 1, further comprising:
anhydrous citric acid having a concentration of approximately 1.0 (wt/Vol) %;
peroxidase having a concentration of approximately 0.012 (wt/Vol) %;
dimethyl sulfoxide having a concentration of approximately 50 (wt/Vol) %;
polyvinyl pyrrolidone having a concentration of approximately 0.5 (wt/Vol) %; and
wherein the tetramethylbenzidine has a concentration of approximately 0.11 (wt/Vol) %.

8. The reagent as recited in claim 1, wherein the reagent is a liquid solution.

9. A test strip for detecting exogenous oxidants in urine, the test strip comprising:
a substrate;
a reagent formed upon the substrate, the reagent comprising tetramethylbenzidine.

10. The test strip as recited in claim 9, wherein the reagent further comprises:
an acidic buffer;
a catalyst;
a medium for carrying out chemical reactions; and
a resinous material.

11. The test strip as recited in claim 9, wherein the reagent further comprises:
an anhydrous acid;
an enzyme catalyst;
a solvent medium for carrying out chemical reactions; and
a water soluble resinous material.

12. The test strip as recited in claim 9, wherein the reagent further comprises:
anhydrous citric acid;
peroxidase;
dimethyl sulfoxide; and
polyvinyl pyrrolidone.

13. The test strip as recited in claim 9, wherein the reagent further comprises:
anhydrous citric acid having a concentration of between approximately 0.05 (wt/Vol) % and approximately 5.0 (wt/Vol) %;
peroxidase having a concentration of between approximately 0.003 (wt/Vol) % and approximately 0.030 (wt/Vol) %;
dimethyl sulfoxide having a concentration of between approximately 20 (wt/Vol) % and approximately 70 (wt/Vol) %;
polyvinyl pyrrolidone having a concentration of between approximately 0.1 (wt/Vol) % and approximately 2.0 (wt/Vol) %; and
wherein the tetramethylbenzidine has a concentration of between approximately 0.020 (wt/Vol) % and approximately 0.300 (wt/Vol) %.

14. The test strip as recited in claim 9, wherein the reagent further comprises:
anhydrous citric acid having a concentration of approximately 1.0 (wt/Vol) %;
peroxidase having a concentration of approximately 0.012 (wt/Vol) %;
dimethyl sulfoxide having a concentration of approximately 50 (wt/Vol) %;
polyvinyl pyrrolidone having a concentration of approximately 0.5 (wt/Vol) %; and
wherein the tetramethylbenzidine has a concentration of approximately 0.11 (wt/Vol) %.

15. A method for detecting exogenous oxidants in urine, the method comprising:
providing a urine sample;
combining the urine sample with a reagent to form a test solution, the reagent comprising tetramethylbenzidine; and
sensing a color of the test solution, the color of the test solution being indicative of the presence of an exogenous oxidant in the urine sample.

16. The method as recited in claim 15, wherein the reagent further comprises:
an acidic buffer;
a catalyst;
a medium for carrying out chemical reactions; and
a resinous material.

17. The method as recited in claim 15, wherein the reagent further comprises:
an anhydrous acid;
an enzyme catalyst;
a solvent medium for carrying out chemical reactions; and
a water soluble resinous material.

18. The method as recited in claim 15, wherein the reagent further comprises:
anhydrous citric acid;
peroxidase;
dimethyl sulfoxide; and
polyvinyl pyrrolidone.

19. The method as recited in claim 15, wherein the reagent further comprises:
anhydrous citric acid having a concentration of between approximately 0.05 (wt/Vol) % and approximately 5.0 (wt/Vol) %;
peroxidase having a concentration of between approximately 0.003 (wt/Vol) % and approximately 0.030 (wt/Vol) %;
dimethyl sulfoxide having a concentration of between approximately 20 (wt/Vol) % and approximately 70 (wt/Vol) %;
polyvinyl pyrrolidone having a concentration of between approximately 0.1 (wt/Vol) % and approximately 2.0 (wt/Vol) %; and
wherein the tetramethylbenzidine has a concentration of between approximately 0.020 (wt/Vol) % and approximately 0.300 (wt/Vol) %.

20. The method as recited in claim 15, wherein the reagent further comprises:
anhydrous citric acid having a concentration of approximately 1.0 (wt/Vol) %;
peroxidase having a concentration of approximately 0.012 (wt/Vol) %;
dimethyl sulfoxide having a concentration of approximately 50 (wt/Vol) %;
polyvinyl pyrrolidone having a concentration of approximately 0.5 (wt/Vol) %; and
wherein the tetramethylbenzidine has a concentration of approximately 0.11 (wt/Vol) %.

21. The method as recited in claim 15, wherein sensing a color of a test solution comprises sensing the color of a test solution with a human eye.

22. The method as recited in claim 15, wherein sensing a color of a test solution comprises sensing the color of a test solution with an electronic sensor.

23. The method as recited in claim 15, wherein combining the urine sample with a reagent comprises wetting a test strip with urine.

24. The method as recited in claim 15, wherein providing the urine sample, combining the urine sample with a reagent, and sensing the color of the test solution are part of an automated process.
